(19) United States
(12) Patent Application Publication
(10) Pub. No.: US 2011/0291342 A1
(43) Pub. Date: Dec. 1, 2011

(54) Support arrangement

(76) Inventors: Nabil Gindy, Nottingham (GB); Yan Wang, Nottingham (GB); Mark Daine, Nottingham (GB); Kevin Walker, Nottingham (GB)

(21) Appl. No.: 12/998,161

(22) PCT Filed: Sep. 23, 2009
(86) PCT No.: PCT/GB2009/002275

§ 371 Date: Aug. 15, 2011

(30) Foreign Application Priority Data
Sep. 23, 2008 (GB) 0817376.7
Dec. 5, 2008 (GB) 0822215.0

(51) Int. Cl. B25B 1/24

(52) U.S. Cl. 269/266

(57) ABSTRACT

Support engagement arrangements (100, 200, 1100, 1200, 2100, 3100, 3200) for utilisation in vices and presentation of components is a necessity, it is known to provide arrangements in which an array of engagement elements (2, 54, 64, 82, 92, 112, 902, 1401, 2003) are presented such that the elements can be displaced in order that ends define a reciprocal profile to a component (7, 57, 67, 87, 97, 117, 407, 1424, 2000). Retention of that reciprocal profile with prior arrangements is difficult. By providing the engagement elements supported upon a volume of particles (6, 56, 65, 86, 96, 116, 406, 806, 1402, 2006) which can act as a fluid medium relative displacement between the engaged elements can be achieved. Once displacement into a reciprocal profile is achieved the volume of particles is locked by actuator (4, 84, 94, 114, 404, 804, 904, 2007) pressure and therefore in support of a component resistance to vibration and other factors is significantly enhanced. Additionally, side clamping (204, 2005) traditionally used with regard to engagement element arrays can be added to further reinforce retention of the reciprocal profiling.

The present invention relates to support arrangements and more particularly to support arrangements utilised to present and support components such as aerofoils for assembly and machining processes.

It will be understood it is well known that components typically require support for a number of manufacturing processes. These processes may include assembly as well as initial forming through moulding etc. It will also be understood that components may require presentation and support simply for storage or inspection and measurement. Unfortunately some components such as aerofoils and wings are of a relatively delicate nature but have curved or irregular surfaces which must be appropriately supported. It will be understood that traditionally bespoke rigs and other support arrangements have been made for each component type. This is costly and time consuming as well as requiring storage of each support arrangement when not required.

Ideally a modular reconfigurable support arrangement should be used which has adaptability for a number of component types and sizes. One approach taken previously is to provide so-called pin arrays. These pin arrays comprise a number of engagement elements in the form of pins arranged to move such that the ends of the pins define a profile for support and presentation of a component. The pin arrangement may be of a positive displacement type or a passive displacement type. With positive displacement arrangements the engagement elements in the form of pins are individually moved in order to define the profile before the component is loaded for support. Passive arrangements generally move the pins into engagement with the component and once engagement is achieved attempts are made to lock the pins in that position for support. It will be understood that close proximation to the component profile is ideal in order to create best support for manufacturing and other processes in use.

Positive displacement pin arrangements have difficulties in that generally each pin must be adjusted and locked. This is a time consuming and expensive process and therefore such pin array support arrangements have limited applicability. Passive pin array support arrangements are attractive but it will be understood in order to create adequate support through the ends of the engagement elements in the form of pins it is necessary to have a large number of these pins and in such circumstances generally it is necessary to depend upon pin-to-pin friction to maintain location of the pins in use. Such friction may be inadequate for some manufacturing processes which may induce vibrations and where coolant or lubricants may be used. The support arrangements should be essentially stable when supporting a component.

In accordance with aspects of the present invention there is provided a support arrangement comprising a housing having an aperture to present a plurality of engagement elements, the housing retaining a volume of particles in fluid association to present at least some of the engagement members, the volume of particles displaceable as a fluid to move the at least some of the engagement elements to adopt a reciprocal profile by end portions of the engagement members against a component in use and the arrangement including means to lock the volume and/or at least some of the engagement elements in the reciprocal profile.

Typically, the particles comprise balls or spheres. Generally, the particles are shaped and/or have a size and/or are configured to facilitate fluid flow under compression within the housing. Generally, the particles are all of substantially the same size. Typically, the particles have a smooth surface.

Generally, the engagement member comprises fingers projecting from the housing. Typically, the engagement members have a round or square cross section. Possibly, the engagement elements include a waisted rebate or slot for engagement by the means to lock the engagement members in the reciprocal profile.

Typically, the rebates or slots in adjacent engagement members overlap. Generally, retainer members engage the waisted rebates or slots to retain engagement member position in the reciprocal profile. Generally, the engagement members have rounded ends.

Typically, the volume of particles is displaced by a plate and axial actuator. Typically, the axial actuator is a rod or a piston. Generally, the rod or piston is associated with the plate on one side of the volume of particles and the engagement members are on the other side of the volume of particles. Generally, the axial actuator operates through a screw bolt or mechanical or electrical displacement mechanism.

Possibly, the volume of particles incorporates a lubricant or gel to facilitate fluid movement of otherwise solid particles.

Also in accordance with aspects of the present invention there is provided an apparatus comprising two arrangements as described above in opposition to each other with the respective engagement elements facing each other to define a vice or holding assembly. Typically each of the arrangements is presented upon a base and the base is relatively displaceable in order to further facilitate presentation between the engagement members.

Other features of the present invention are defined in the dependent claims.

Aspects of the present invention will now be described by way of example only with reference to the accompanying drawings in which:

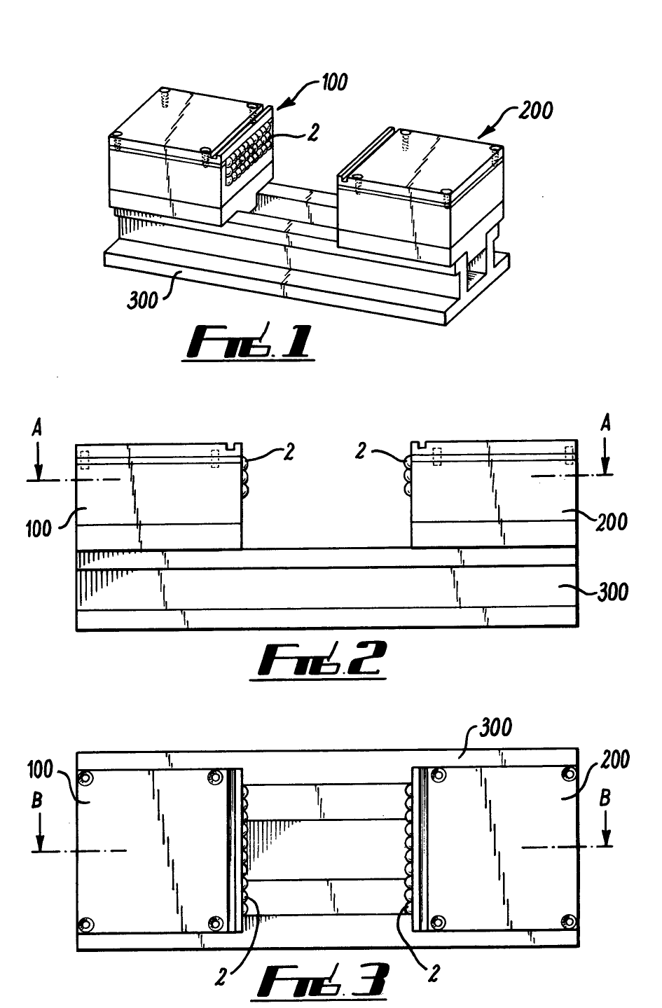

FIG. 1 is a front perspective view of an apparatus incorporating presentation arrangements in accordance with aspects of the present invention;

FIG. 2 is a side view of the apparatus as depicted in FIG. 1;

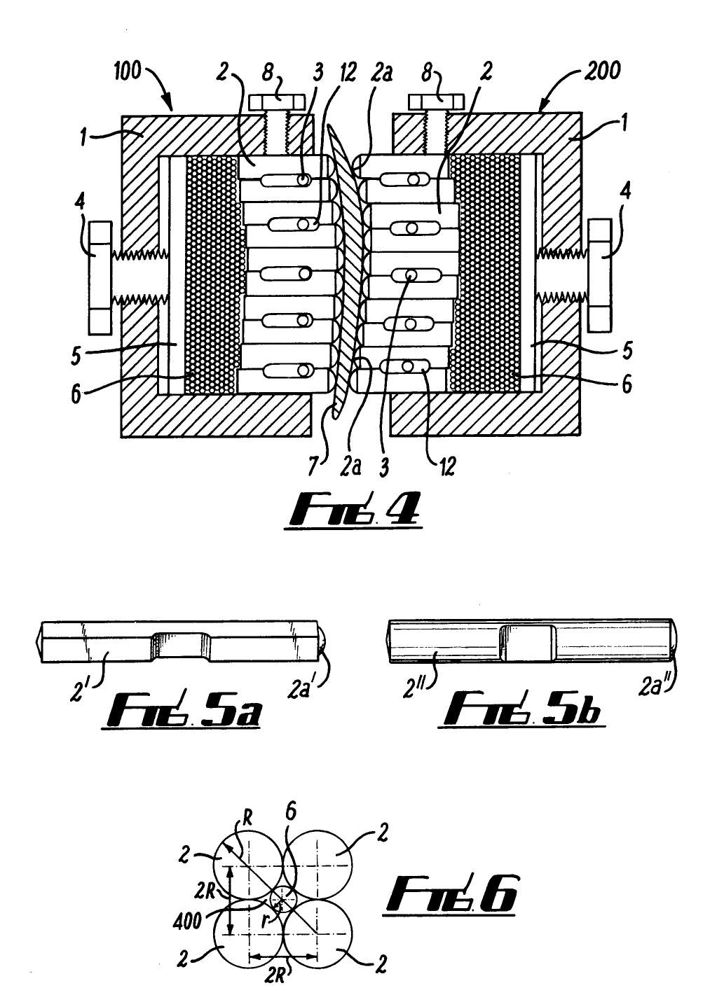

FIG. 3 is a plan view of the apparatus as depicted in FIG. 1 and FIG. 2;

FIG. 4 is a cross section along the line A-A depicted in FIG. 2;

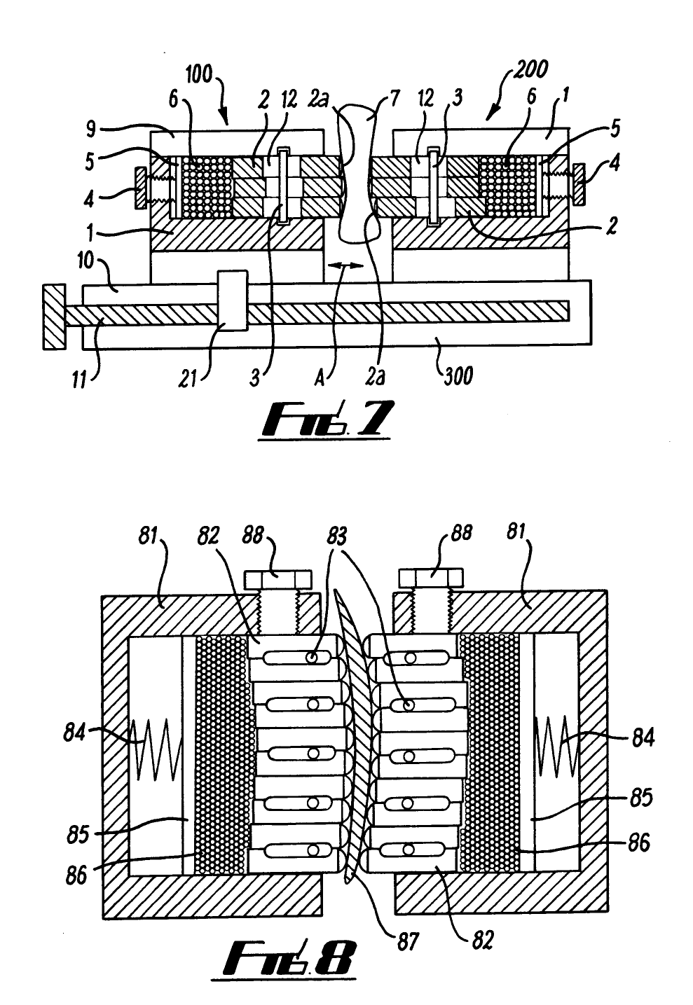

FIG. 5 illustrates respective engagement elements in accordance with aspects of the present invention;

FIG. 6 illustrates association with regard to engagement elements in a round cross section format and particulate members utilised in accordance with aspects of the present invention;

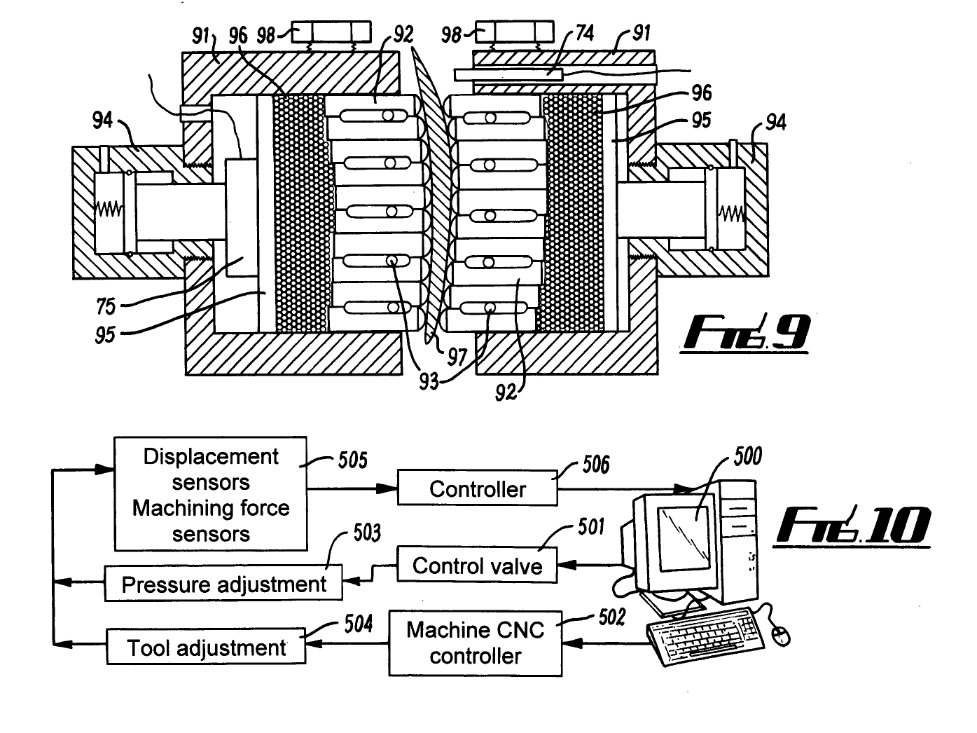

FIG. 7 is a cross section in the plane B-B depicted in FIG. 2;

FIG. 8 is a cross section in accordance with alternative aspects of the present invention utilising mechanical springs;

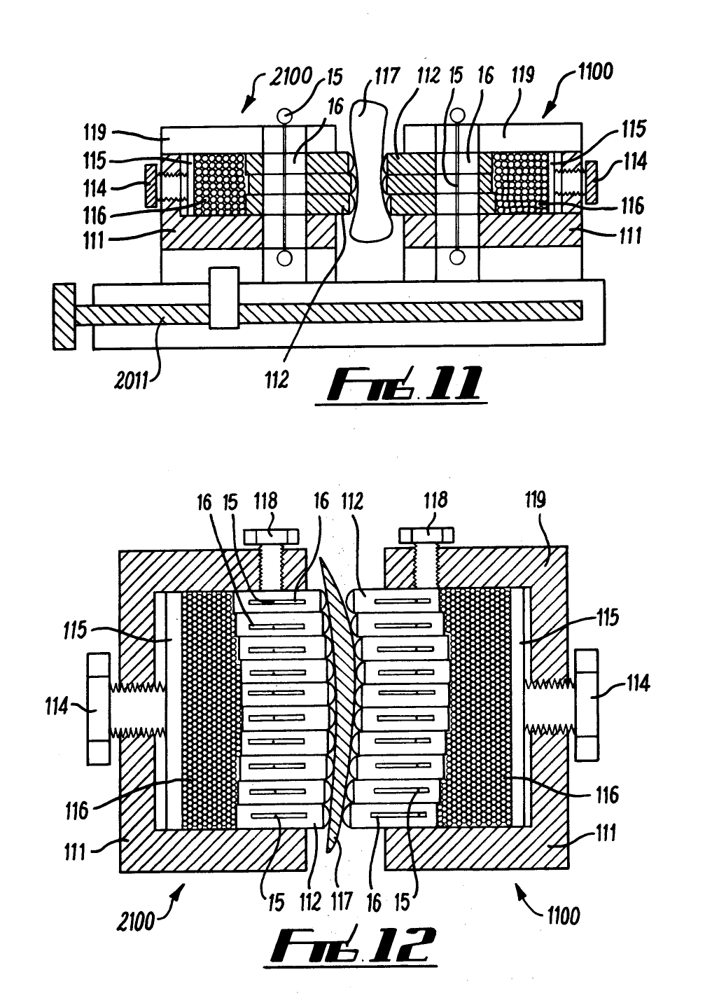

FIG. 9 is a cross section of an arrangement in accordance with aspects of the present invention utilising pneumatic piston actuators;

FIG. 10 illustrates a control system for an apparatus or arrangement in accordance with aspects of the present invention;

FIG. 11 is a cross section of an arrangement in accordance with aspects of the present invention utilising wires for engagement element retention;

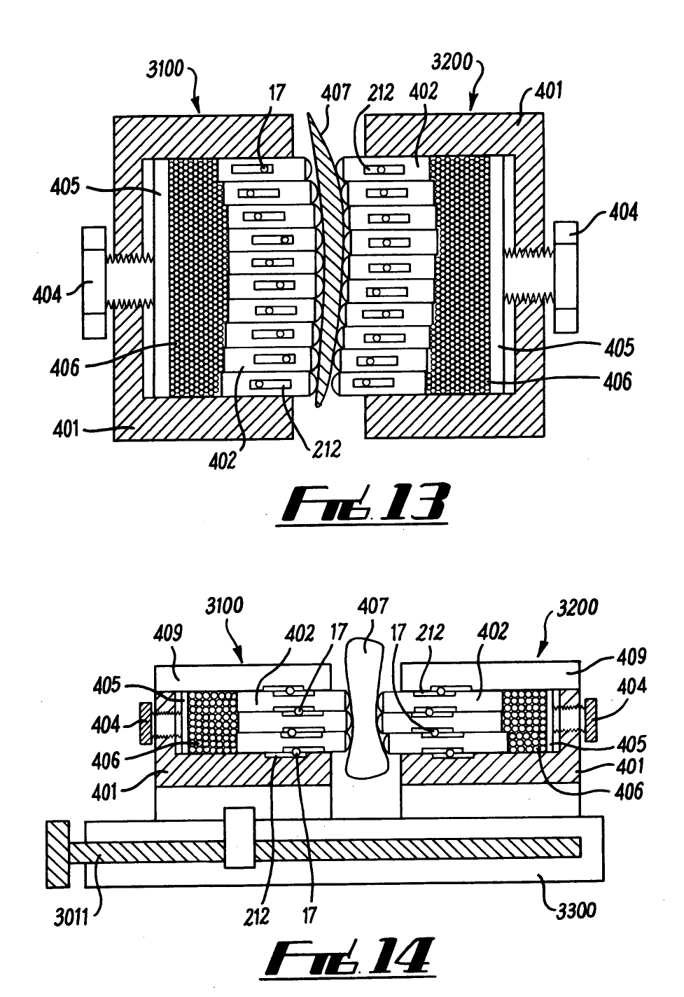

FIG. 12 is a cross section of the arrangement and apparatus as depicted in FIG. 11 in plan view;

FIG. 13 is a cross section in plan view of an apparatus and arrangement configured to retain engagement elements in accordance with aspects of the present invention;

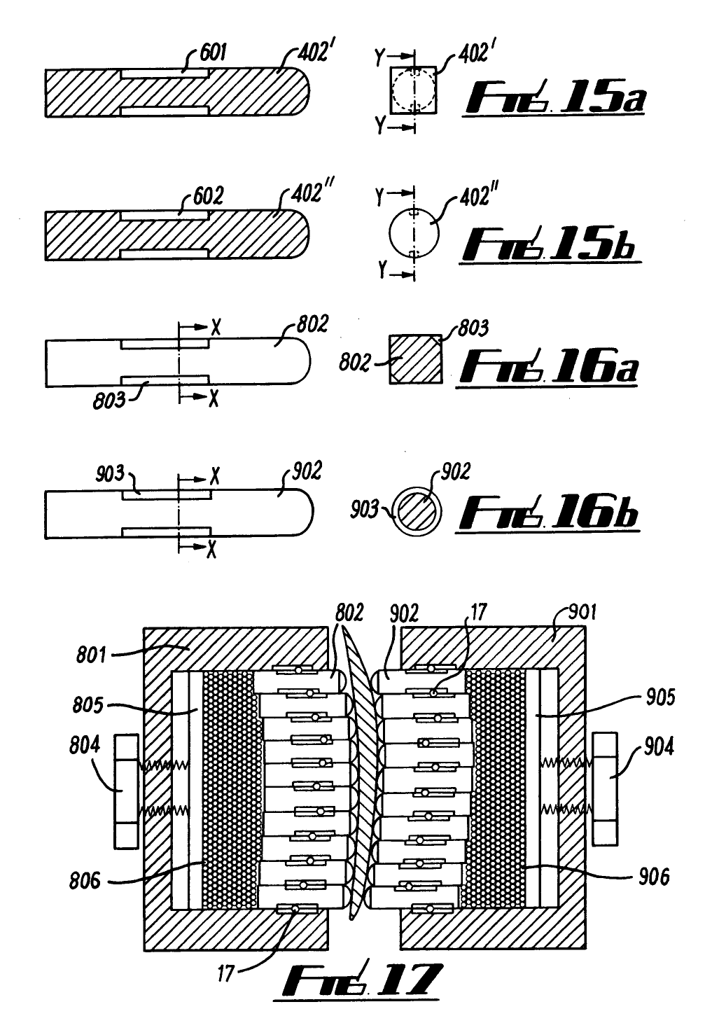

FIG. 14 is a cross section of the arrangement and apparatus as depicted in FIG. 13 in side cross section;

FIG. 15 provides schematic illustrations of square and round engagement elements in accordance with aspects of the present invention;

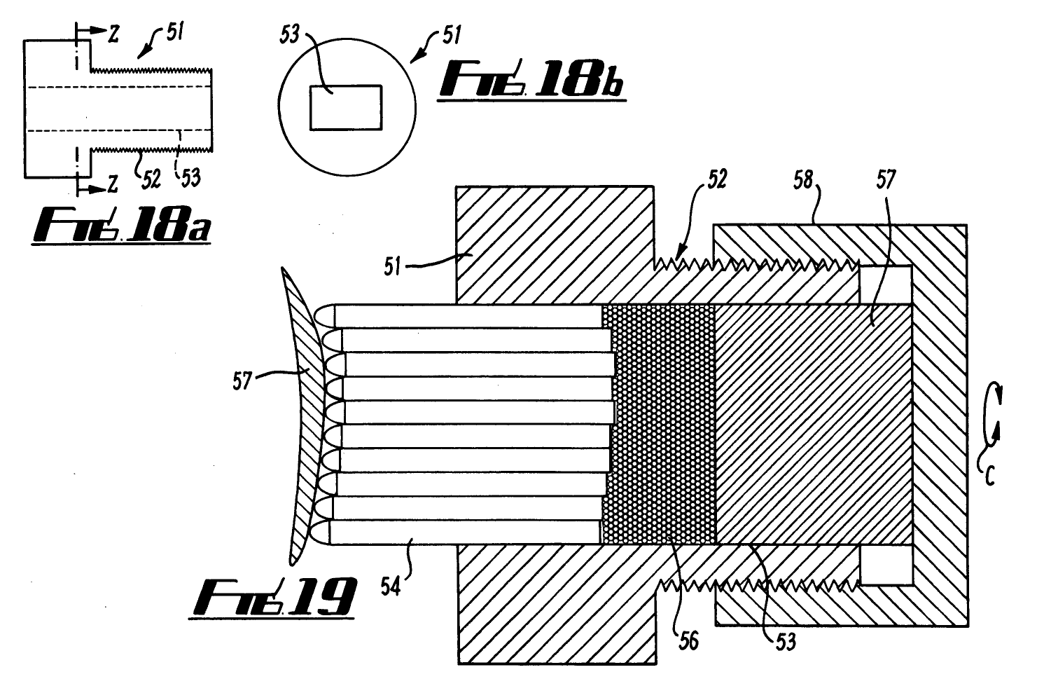

FIG. 16 is a schematic illustration of alternative engagement element geometry in accordance with aspects of the present invention;

FIG. 17 illustrates a further alternative with regard to support arrangements and apparatus in order to define a holding system for a component;

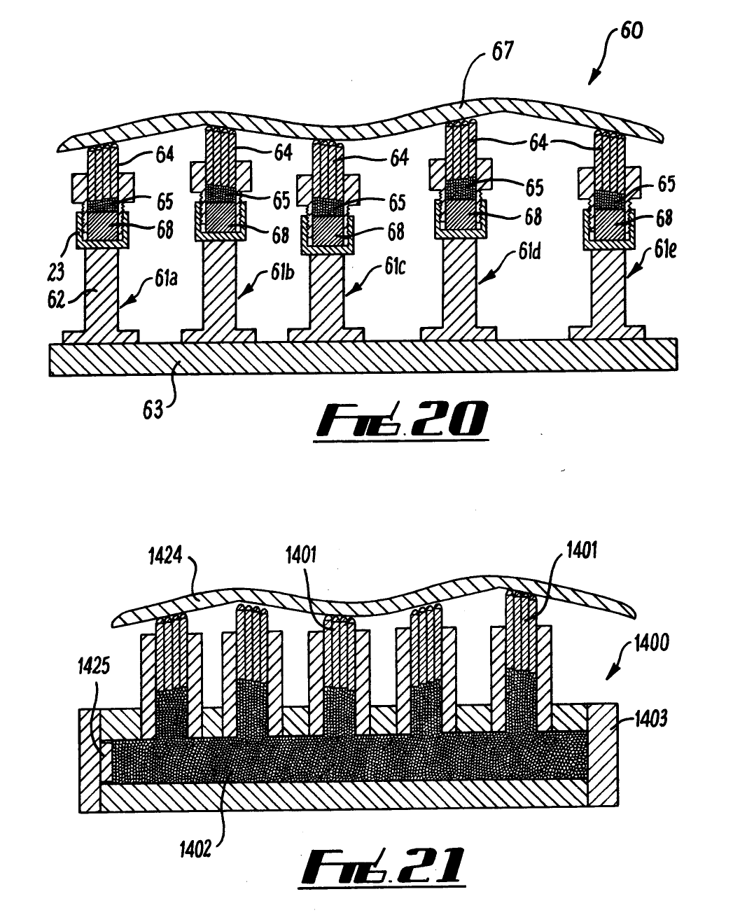

FIG. 18 is a schematic illustration of a screw housing utilisable in accordance with aspects of the present invention;

FIG. 19 is a cross section of an arrangement in accordance with aspects of the present invention utilising a screw housing as illustrated in FIG. 18;

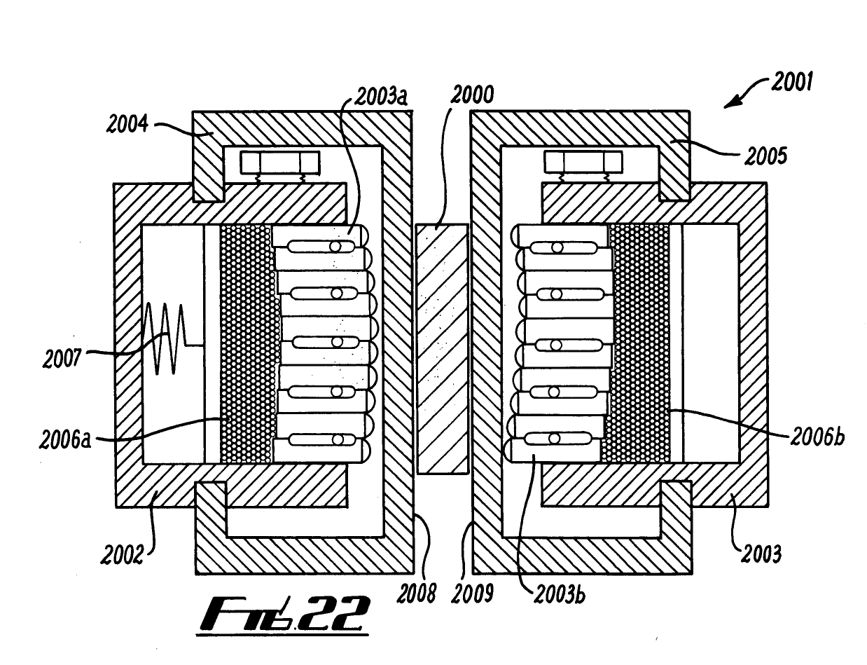

FIG. 20 illustrates utilisation of a number of arrangements in accordance with aspects of the present invention to support a large component;

FIG. 21 illustrates an apparatus similar to that depicted in FIG. 20 but with flow between support arrangements across the component; and,

FIG. 22 provides a schematic illustration of an additional modification to an arrangement in accordance with aspects of the present invention.

Aspects of the present invention particularly relate to provision of holding apparatus which comprises engagement or support arrangements to act against a work piece. The work piece may be sandwiched between the engagement arrangement and a hard vice jaw or two engagement arrangements in accordance with aspects of the present invention may be arranged in an apparatus in an opposed configuration to locate the component between. FIGS. 1 to 3 illustrate such a holding or vice apparatus utilising two arrangements in accordance with aspects of the present invention. The arrangements 100, 200 are secured upon a base 300 which allows relative lateral movement to bring the arrangements 100, 200 together for further gripping effect in use. As will be described later a single arrangement in accordance with aspects of the present invention could also be utilised for simple support and presentation in engagement with a component. Nevertheless, the principal application of arrangements in accordance with aspects of the present invention is with regard to a vice like holding apparatus in which engagement members 2 typically in the form of pins are presented to engage a component through end portions. The engagement members or elements 2 are normally in an array with rounded ends for appropriate engagement with the component. In accordance with aspects of the present invention the engagement elements or members 2 are presented upon a volume of particles generally of a small size such as ball bearings or otherwise. The particles have smooth shapes to facilitate and emulate a fluidic volume. The particles are normally all of the same size. In such circumstances when a pressurising force is presented to the volume of particles the fluidic nature of the particles forces the engagement elements or members to move forward into engagement reciprocally with the component to be supported. Once in engagement, means such as a method of locking the fluidic pressurisation within the volume of particles or otherwise maintains the orientation and configuration of the engagement members 2 in the reciprocal profile with the component to be supported and engaged. In such circumstances as depicted in FIGS. 1 to 3 the respective arrangements 100, 200 can then be advanced or moved upon the base 300 to further increase the holding and engagement forces on the component. It is providing close reciprocal profiling of the engagement members 2 that allows more appropriate and convenient presentation and support of a component in use. It will be understood there may be fixed engagement elements which extend from the housing of the arrangement. These fixed engagement elements will provide a base reference for the component which may include urging to a tilt or other angle to the base for the component which is supported. These fixed engagement elements may be positively displaced to slightly alter the base reference orientation.

FIG. 4 provides a cross section in the direction A-A as depicted in FIG. 2 above. As can be seen the engagement members in the form of pins or fingers 2 move generally axially into engagement with a component 7. For illustration purposes the component 7 is an aerofoil which as can be seen has curved surfaces. The engagement members or elements 2 are presented upon a volume of particles 6 in the form of solid balls. These particles 6 act as a fluid such that when a pressurising force through a board or piston 5 acts against the particles 6 the engagement members 2 are variously displaced a necessary distance such that an end 12 engages the component 7. The board 5 in effect sweeps and compresses the particles 6 as indicated as a fluid. The pressure force is created through a bolt 4 in the embodiment depicted in FIG. 4 but as will be described later there are alternatives for creating fluidic motion in the particles 6 to variously displace the engagement elements 2. The particles 6 are confined between the board 5 and rear parts of the engagement elements 2. The confinement is within a cavity formed by a housing 1. It will be understood that the housing 1 in such circumstances must be sufficiently robust to act as a jaw within a vice like arrangement as depicted in FIGS. 1 to 4 as well as to allow mounting upon a base to allow further typically more forceful grip engagement as a result of displacements upon that base in use.

Once the engagement elements 2 are in place it will be understood that a particular advantage with regard to aspects of the present invention is that this position is supported and retained essentially by the fluidic pressure created through the actuator 4 and the engagement elements 2 in contact and in engagement with the component 7. Such a configuration is in comparison with prior arrangements where essentially friction between the engagement element arrays is utilised for retaining element position. Further in accordance with aspects of the present invention retaining pins or other mechanisms 3 in association with a lock force 8 ensure the engagement elements 2 and particles 6 such as ball bearings do not fall out of the housing.

It will be understood that the configuration as depicted in FIG. 4 is of a typical vice construction. Thus the arrangements 100, 200 act as jaws within the vice such that the respective housings 1 as illustrated are laterally displaceable to provide engagement pressure by the engagement elements 2 against the component 7. As illustrated the actuator 4 in the form of a bolt pushes the board 5 which moves forward the particles 6 in a fluidic process of slide and slip between the particles 6 in the form typically of ball bearings with a smooth surface. This fluid movement of the volume of particles 6 pushes the engagement members 2 forwards to contact the component 7. Generally, the engagement members or elements 2 may have a square cross section or a round cross section as described below with regard to FIG. 5. Generally square pushing pins are utilised for illustration with regard to aspects of the present invention.

It will be understood that it is important that the engagement profiling with the component 7 is generally sympathetic to the shaping of that component 7. In such circumstances generally the ends 2a are rounded to provide a smooth point contact between the members or elements 2 and the component 7. However, any shape may be cut or provided at the other end of the engagement elements 2 in order to contact the particles 6 and so facilitate contact and release thereabout.

Typically, an intermediate rebate or slot 12 is cut into each engagement element 2. The slot 12 in association with retaining pins or members 3 acts to ensure the engagement end members 2 and particles 6 cannot be pushed out of the housing 1 by the actuator 4.

FIG. 5 provides illustrations respectively in FIG. 5a a square cross section engagement member 2′ and in FIG. 5b of a round cross section engagement member 2″. As described previously a number of these members 2 will be located in an appropriate array such that an engagement end 2a will be presented in engagement with a component whilst an opposite end will be engaged by particles in order to cause appropriate displacement into such engagement with the component. By such an arrangement a reciprocal profile is created by the ends 2a with the component which can then sympathetically hold and present that component for simple access or to allow machining processes.

As indicated above the engagement members may be of a square or round cross section but in any even the cross section must be considered in view of the necessity for containment of the particles. It will be understood the particles are generally of a solid ball like nature with the smaller the particle size the better in order that the particles in the volume of particles can act as a fluid medium. Such fluid mediums when pressurised will then move forward the engagement members into contact with the work piece. Where the cross section of the engagement members is other than square it will be understood that for example with a round cross section engagement member consideration must be made to the gap effectively between adjacent engagement members. If the gap is too big then clearly small sized particles in the volume of particles may escape between adjacent side by side engagement members in accordance with aspects of the present invention. It will be understood the particles 6 act as a fluid so may escape if care is not taken with gaps between adjacent engagement members or effective “seal” structures provided.

As indicated above once the engagement members are in position, that is to say the ends 2a are in reciprocal profile with the component 7 it will be understood that a retention or clamping bolt 8 is used to lock the engagement members in position. Such side clamping of the engagement members ensures a degree of repeatability with regard to clamping subsequent components having substantially the same shape as an initial component.

FIG. 7 provides a cross section in the plane B-B of the apparatus comprising arrangements 100, 200. Thus, as previously engagement elements 2 are advanced upon the fluid medium created by particles 6 in a housing 1 through actuation through an actuator 4 and plate or piston 5. The housing 1 is associated with a cover plate 9 to define the containment cavity for the volume of particles 6 and so facilitate creation of the arrangements 100, 200 in use.

It will be noted that the arrangements 100, 200 are mounted upon the base 300. Arrangement 200 is substantially fixed on the base 300 whilst arrangement 100 can move in the direction of arrowheads A to effectively increase or decrease the holding pressure upon the component 7 through the engagement elements 2. To cause slide movement of the arrangement 100 a bolt 11 with an appropriate engagement member 21 is utilised.

The retention pins 3 as indicated above are inserted through holes in the housing 1 and the housing cover 9. Initially, the arrangements 100, 200 are rapidly moved by the bolt 11 in the base 300 such that the ends 2a of the respective engagement members 2 are relatively close to the component 7. Once in such a position the engagement elements 2 can be moved into contact with the surface of the component 7 through the respective actuator bolts 4 in the arrangements 100, 200. In such circumstances the particles 6 act as a fluid medium such that there is appropriate various displacement of the respective engagement elements 2 into engagement with the component 7. Once the ends 2a are in appropriate engagement with the component 7 it will be understood that further clamping forces can be applied through the vice construction created by the arrangements 100, 200 upon the base 300 and the action of the bolt 11 causing displacement in the direction of arrowheads A, that is to say to close the gap between the opposed arrangements 100, 200.

The engagement elements will remain with the reciprocal profile through the ends 2a engaging opposed parts of the component 7 during such movements in the direction of arrowheads A with retention provided by the confinement of the particles 6 with the “pressurisation” of the actuator 4. It will be understood that the engagement elements principally retain their position substantially rigidly and are not pushed back by machining processes upon the component 7 as the particles 6, for example solid balls will interlock with each other after the ends 2a conform to the component shape, that is to say have a reciprocal profile to an opposed part of that component 7.

FIG. 6 illustrates respective engagement components 2 in a side by side relationship. As illustrated above it is important that a gap 400 between the side by side engagement components in a round cross section or otherwise is sufficiently small that particles 6 cannot migrate or move along the gap 400 and so reduce the effectiveness of the arrangement. It will be understood that as indicated above generally smaller particles 6 are advantageous in order to create a fluid medium but smaller particles where the engagement members have anything other than a square cross section or where a seal is not provided must have a gap 400 sufficiently small to prevent particle migration and ingress. It will be understood that it is possible to provide in effect a mesh or membrane across the ends of the engagement members 200 such that the particles act upon that membrane and so cannot migrate along the gap 400. However, such membranes may blunt and diminish the effectiveness of contact forces on the respective engagement members in use and therefore reduce effectiveness in operation. It will also be understood that such membranes by their nature will be elastomeric and therefore may reduce the capability with regard to holding engagement forces which can be presented by the engagement elements in use. Similarly, as described above and below the engagement element ends 2a themselves may have a membrane extending over them in the array to further smooth engagement with the component. However, such a membrane will also act between the ends 2a and the component 7 and therefore adjust and alter engagement forces.

Aspects of the present invention have particular advantages with regard to prior art arrangements. It will be understood in prior art arrangements the engagement members in the form of pins as indicated generally are positioned side by side such that friction generated through a clamping force holds the pins as engagement members in position. It will be understood that the side clamp 8 in accordance with aspects of the present invention is principally there as an augmentation to the retention force created by the particles in the volume of particles in accordance with aspects of the present invention. Simply depending upon friction generated between the engaged side by side parts of the engagement element has problems with regard to unreliability. It will be understood that engagement arrangements typically are subject to machining and assembly distortions which may create respectively dynamic vibrations and various loadings upon the component in use. Such variations which may also include the presence of lubricants and coolants in machining processes will limit the capability with regard to depending purely upon side by side friction for retention of engagement member or element retention in position. Thus, although lubricants may be used in the volume of particles 6 such lubricants may limit locking of the particles 6 position and so retention of the engagement elements 2 in engagement with the component 7. However, air pressure in the cavity may facilitate particle fluid movement when required and be removed when not for “lock down”.

As indicated above the crux of aspects of the present invention relates to provision of a particle volume which acts as a fluid medium for transfer of displacement to the engagement members variously to engage a component surface. Typically fluid motion is created by pressurisation in the form of an actuator 4 as described above. Alternatively as depicted in FIG. 8 a physical actuator in the form of a screw driven bolt may be replaced by a spring 84. In such circumstances it will be appreciated as respective arrangements as depicted in FIG. 8 are brought together the spring 84 in each arrangement will pressurise the particles 86 in a volume behind the engagement elements 82. This pressurisation will typically be against relative displacement through a vice like arrangement with a drive bolt 11 as depicted in FIG. 7. In such circumstances the spring using the plate 86 will cause fluid motion in the particles 86 such that through equalisation of pressure the engagement elements 82 will variously move such that their ends engage the component 87. In order to enhance retention of the profile created by the ends of the elements 82 a side lock or retention bolt 88 may act to increase friction force between the side parts of the elements 82 and in addition stop or retention pins 83 may be provided in recess slots to ensure the engagement elements and particles remain within the housing. Nevertheless, retention of engagement element 84 position is generally through particle surface contact lock between particles 86 under pressure against the component surface.

A further alternative is depicted in FIG. 9 where the actuator bolt 4 or spring 84 depicted in previous embodiments is replaced with a double or single acting hydraulic or pneumatic actuator 94 and piston 95. In such circumstances the actuator 94 will again displace the plate piston 95 to cause pressurisation of the particles 96 in a volume behind the engagement elements 92. Thus there will be various displacements of the engagement elements 92 such that their ends define a reciprocal profile with a component 97. The profile created may be retained through a side bolt 98 and retainer pins or elements 93.

In the above embodiments it will be understood the common features are with regard to the particles defining a fluid medium. This fluid medium allows differential movement and displacement of the engagement elements 92. Manually active driving of an engagement bolt 4 as described above can be performed as indicated manually or through a worm gear or otherwise. The use of a spring 84 provides an inherent bias within the arrangements in order to create fluidisation and therefore distribution and displacement of the engagement elements 82. However, by provision of a worm gear or hydraulic/pneumatic cylinders as described above with regard to FIGS. 1 to 7 and FIG. 9 it will be understood that feedback control is possible. In such circumstances a sensor 74 can be incorporated in one or both of the arrangements in accordance with aspects of the present invention. The sensor is generally a displacement sensor or could be a proximity sensor to measure in line displacement of the component 97 during machining whilst force sensors 75 may measure machine forces such that if deformation is excessive or the component 97 moves a control system can then calculate a necessary response. This response may relate to the amount of force needed in order to control the component 97 in use. The force may be reduced or increased in order to avoid deformation or work piece movement and particularly through use of feedback to a hydraulic or pneumatic actuator and control valve pressurisation for displacement of the fluidic medium comprising the particles 6, 96 in use.

FIG. 10 provides a schematic illustration of a potential control regime. Thus, a control system 500 provides control signals to a control valve 501 which adjusts the pressure, that is to say displacement pressure in the volume of particles in accordance with aspects of the present invention for adjustment of the engagement elements through a pressure adjustment step 503. Similarly, the control regime 500 through a controller 502 adjusts machining tools or otherwise engagement adjustments 504 upon a component in use. Through the sensors associated with the arrangements and apparatus in accordance with aspects of the present invention signals are then presented by the sensors 505 to a control element 506 whereby the control system 500 can adjust the control valve 501 or controller 502 for reciprocal action. In such circumstances the engagement arrangements in accordance with aspects of the present invention can be dynamically adjusted dependent upon machining or other presentational variables in use.

As indicated above generally retaining pins 3, 83, 93 will be utilised in order to retain engagement member position. These retaining pins prevent the particles typically in the form of solid balls and engagement members from falling from housings providing engagement in accordance with aspects of the present invention. As depicted in FIG. 11 and FIG. 12 an alternative is to provide wires which extend through the engagement elements. FIG. 11 is similar to FIG. 7 with regard to illustrating arrangements in accordance with aspects of the present invention in the plane B-B depicted in FIG. 3 whilst FIG. 12 provides a similar illustration to FIG. 4 in the orientation A-A depicted in FIG. 2. In such circumstances it will be understood that the slot 12 as depicted previously is replaced by a cut out or rebate section 16 more clearly depicted in FIG. 12. It will be understood it is in this cut out section 16 that a wire 15 is presented to retain the engagement elements 112 in position. In other respects the arrangement as depicted in FIG. 11 and FIG. 12 is similar in operation to as described previously. Thus, an actuator 114 to a plate 115 will pressurise a fluid medium created by particles 116 such that there is various displacement for pressure equalisation in the engagement elements 112 against a component 117. Cut outs or slots 116 in each element 112 will then incorporate a wire 15 to retain the elements 112 and so the particles 116 typically in the form of solid balls in a cavity defined by a housing 11 and a cover plate 119. In such circumstances in use as described above once end parts of the engagement members 112 engage the component 117 retention of the reciprocal profile created is achieved by pressurisation. The wire 15 and actuator 114 ensure the engagement elements 112 and particles 116 remain within the housing. Further presentation and engagement forces can be created through a vice like arrangement in which one arrangement 1100 is fixed to a base whilst another arrangement 2100 is laterally displaceable by an actuator bolt 2011.

As previously where a wire is used to retain the engagement elements 112 within the housing 111 it is also still possible to provide a lateral clamping bolt 118 which forces friction between the elements 112 to a reciprocal end profile retention in engagement with a component 117. Such retention of position may be beneficial with regard to processing a number of components 117 sequentially which has substantially the same shape.

FIGS. 13 and 14 illustrate a further alternative to use of wires 15 or retention pins 3 as described with previous arrangements. In order to prevent the engagement elements and fluid medium particles falling out of the arrangements in accordance with a further embodiment depicted in FIG. 3 and FIG. 4 spherical balls 17 are provided. In order to accommodate the balls 17 each engagement element is modified to provide rebate slots 212. Operation of the arrangements 3100, 3200 is as described previously in that particles 406 in a volume defined by a housing 401 are compressed by an actuator 404 through a plate 405 such that there is various displacement of the engagement elements 402 into engagement with a component 407. Retention is through the pressurisation and friction lock of the particles 406. The spherical balls 17 in the slots 212 ensure that the engagement elements 402 as well as the particles 406 do not fall out of the apertures in the housing 401 in association with the cover plate 409. As previously generally arrangements 3100, 3200 will be secured upon a base 3300 with one arrangement 3200 fixed to the base 3300 and the other arrangement 3200 displaceable by a vice actuater bolt 3011 in use.

It will be appreciated that shaping of the slots formed in the engagement elements 402 is important with regard to retaining engagement element 402 position through use of spherical balls 17. FIG. 15 provides illustrations of respective engagement elements 402′, 402″ respectively in a square cross section and a round cross section. Each illustration shows an end cross section, respectively in a square (a) and a round (b) configuration. Thus, each engagement element 402 as illustrated has waisted slots 601, 602 in a plane Y-Y. It will be understood that the spherical balls 17 will be captured in the slots 601, 602 respectively dependent upon the configuration used. With regard to engagement elements adjacent to the housing 401, a plate 409 has rebated slots or portions of slots formed in these components 401, 402. In such circumstances the spherical balls will limit displacement distance at least relatively between adjacent engagement elements 402 in operation. Such limitation will prevent such elements 402 falling out of the arrangements 3100, 3200 in accordance with aspects of the present invention.

Further alternatives are illustrated in FIG. 16 to provide variations with respect to the slots formed in the engagement elements within which the spherical balls operate. Thus, as illustrated in FIG. 16a is to provide a square cross section engagement element 802 in which in a mid section a waist rebate is created by corner chamfers 803. The corner chamfers 803 in a side by side relationship in an array for engagement elements 802 will create a slot within which the spherical balls are retained for retention of the engagement elements 802 in use.

With regard to FIG. 16b having a round cross section essentially a rebate is created about the whole or part of the circumference of an engagement element 902 again within which a spherical ball is captured for retention of the engagement element 902 in position.

FIG. 17 provides a cross section in which the configuration as described in FIG. 16 with regard to engagement elements 802, 902 is described. Again spherical balls 17 act in the slots 803, 903 to retain engagement elements 802, 902 in position within respective housings 801, 901. General operation of the arrangements in accordance with aspects of the present invention is as described previously in that a volume of particles 806, 906 is again provided as a medium in fluid association between the engagement elements 802, 902 and a plate 805, 905 in order to displace the elements 802, 902. In such circumstances a component 807 is again retained between the opposed arrangements having engagement elements 802, 902 in accordance with aspects of the present invention.

An alternative to utilising a housing and housing cover as described with previous arrangements is to provide a screw housing to accommodate the engagement elements and an actuator block screwed onto the screw housing. FIGS. 18 and 19 illustrate such an arrangement. In such circumstances the actuator in the form of a pushing bolt or spring or pneumatic/hydraulic ram is avoided.

FIG. 18 provides illustration with regard to FIG. 18a of a front cross section of a screw housing 51 with a screw stem 52. A cavity 53 is created within the housing 51. As will be described later this cavity 53 accommodates the engagement elements in accordance with aspects of the present invention along with particles which define the fluid medium for various displacements of the engagement elements into contact with a component. As depicted in FIG. 18b this cavity 53 substantially extends through the housing 51. FIG. 18b illustrates a cross section at Z-Z.

FIG. 19 illustrates the alternative embodiment described above incorporating a screw housing 51 in accordance with aspects of the present invention. In such circumstances as illustrated engagement elements 54 extend towards a component 57. Engagement elements 54 project from the cavity 53 presented upon particles 56. The particles 56 as described previously provide a particulate fluid medium volume which is compressed by an actuator element 57 as part of a cap 58 which engages with the screw thread 52. In such circumstances the actuator element 57 displaces the particles 56 which in turn variously displaces the engagement elements 54 into engagement with the component 57. In such circumstances simple screw movement in the direction of arrowheads C will result in the creation of a profile at the ends of the elements 54 which is reciprocal with an opposed part of the component 57.

As described above provision of a vice configuration is one example of an application of an arrangement in accordance with aspects of the present invention. Such vice arrangements generally comprise an arrangement in accordance with aspects of the present invention opposed by a fixed jaw or another arrangement in accordance with aspects of the present invention. A further alternative would be to simply depend upon gravity to present a component. In such circumstances the component would then simply rest upon the engagement arrangements in accordance with aspects of the present invention. FIG. 20 provides a schematic illustration utilising the embodiment depicted in FIG. 19 in such a support configuration. It will be noted that the component 67 is not clamped by the arrangement 60 as depicted in FIG. 20 but rather rests upon a number of appropriately spaced support arrangements 61 in accordance with aspects of the present invention. These arrangements 61a in the apparatus 60 as described previously have an initial base or stand 62 which is presented upon a surface 63. Each arrangement 60 includes engagement elements 64 presented upon a volume of particles 65 to act as an essential fluid medium. The fluid medium translates pressure created by an actuator 68 as a result of screw thread associations to a desired extent. In such circumstances although each arrangement 61 may be notionally of the same height by the screw thread movement of the actuator 68 it will be understood that each engagement element 64 and in particular ends of each engagement element 64 will define reciprocal profiling to the components 67. In such circumstances complex geometries for the component 67 can be supported by reciprocal shaped profiling of the ends of the engagement component 64 dependent upon presentation on the fluid medium 65 comprising particles. These particles are generally of a hard spherical nature and therefore allow various displacements of adjacent engagement elements 64 in order to define the profile as required.

FIG. 21 illustrates a further modification and adaptation of the general configuration as depicted in FIG. 21 except that an arrangement 1400 has a component 1424 supported by engagement elements 1401 which are presented upon a volume of particles 1402 which extend in a cavity defined by a housing 1403. In such circumstances through a single actuator in the form of a screw thread element 1425 pressurisation of the volume of particles 1402 is achieved and therefore through equalisation of pressure relative and various displacement of the respective elements 1401 into engagement with the component 1424 is achieved. In such circumstances it is possible to support the component 1403 without the necessity of individual adjustment of arrangements 61 as depicted in FIG. 20.

It will be understood that by provision of particles which create a fluid medium adjustment of engagement elements in accordance with aspects of the present invention can be achieved. Generally, the particles will be spherical, hard and solid. Generally these particles may be ball bearings or similar and made of a metal with a smooth surface to facilitate fluid flow until there is engagement between the engagement element and a component. Once there is engagement it will be understood that essentially the particles will then lock in position retaining that position until released by reversing the actuator and so pressurisation or removing the component. The engagement elements can be further retained in position using a conventional side clamp bolt and to ensure the engagement elements do not fall out of the arrangements retainer pins or elements as well as wires or other devices can be used. As an alternative to metal particles it will be understood that hard plastics, ceramic or natural materials may be used. It will also be understood in some circumstances the particles may have a softer surface to facilitate locking when required or the particles themselves rendered hollow or distortable under certain pressures again to lock position. Such distortion may be beneficial in retaining engagement element positions but may inhibit subsequent fluid flow if required by the particles.

Although described principally with regard to components such as aerofoils it will be understood that other components both regular and irregular can be supported by arrangements and apparatus in accordance with aspects of the present invention.

Aspects of the present invention provide a generic reconfigurable clamp and support arrangement for components which have variable geometry. The arrangement is generally modular and can be adapted to a number of situations and therefore allows ease of operation. It will also be understood that the arrangement is generally cheap and easy to maintain in that the particles which allow the fluid medium to adjust the engagement elements will be relatively robust and stable but even so when required these particles can be replaced easily within arrangements. It will be understood that arrangements and apparatus in accordance with aspects of the present invention can be utilised in a number of situations such as with regard to providing clamps for machining and in order to present components for assembly or inspection. Arrangements and apparatus in accordance with aspects of the present invention have a cheap and low maintenance requirement and therefore can be utilised widely for both storage as well as machining/assembly operations. It will also be understood by appropriate sizing and scaling apparatus and arrangements in accordance with aspects of the present invention can be utilised for both small and large installations.

It will be understood in some circumstances components and articles to be supported or held may be of a regular shape. This shape may be rectangular or triangular or at least have a flat or regular surface to be engaged by the arrangement. As depicted in FIG. 22 a box like component 2000 is secured in an arrangement 2001 comprising opposed housings 2002, 2003 in which particles 2006a, 2006b typically in the form of ball bearings present engagement elements 2003a, 2003b to jaw elements 2004, 2005. In such circumstances it will be appreciated that the engagement elements 2003 and particles 2006 operate in a manner as described previously. Thus, the particles 2006 essentially slip and slide relative to each other in a fluid association driven by a bias 2007 or other means. The engagement elements 2003 in such circumstances engage the jaws 2003, 2005 such that the regular surfaces of the jaws 2004, 2005 engage the component 2000. As previously generally the housings 2002, 2003 will be supported themselves upon relatively displaceable mountings to allow movement towards or away from each other in the opposed relationship depicted in FIG. 22. In such circumstances the support aspects of the present invention are achieved by relative displacement of the elements 2003 and a substantially parallel surface to surface engagement achieved between parts of the jaws 2004, 2005 for more efficient location of the component 2000 in use. The jaws 2003, 2004 themselves may also include shaping or other features to allow appropriate engagement with the component 2000. In such circumstances the jaws in opposed surfaces 2008, 2009 may include apertures or pegs or ribs or other features upon which the component 2000 can be located.

Modifications and alterations to aspects of the present invention will be understood by a person skilled in the technology. For example, the engagement elements in accordance with aspects of the present invention will typically be solid elements assembled appropriately within housings with the fluid medium created by particles therewithin. Alternatively, the engagement elements may include detachable end caps which have various shapes including rounded as well as peaked for desirable engagement with different component types. The engagement elements in accordance with aspects of the present invention will typically be confined and therefore generally as described above will move in one direction axially upon the fluid bed. Alternatively, configurations can be created in which the housing defines a gap which acts as a guide for the engagement elements and through which the engagement elements extend. The gap may be straight or circular or an arc with consequent movement accordingly. This may facilitate support and presentation in engagement with different component types particularly where space is at a premium.

1. A support arrangement comprising a housing having an aperture to present a plurality of engagement elements, the housing retaining a volume of particles in fluid association to present at least some of the engagement members, the volume of particles displaceable as a fluid to move the at least some of the engagement elements to adopt a reciprocal profile by end portions of the engagement elements against a component in use and the arrangement including means to lock the volume and/or at least some of the engagement elements in the reciprocal profile.

2. An arrangement as claimed in claim 1 wherein the particles comprise balls or spheres.

3. An arrangement as claimed in claim 1 wherein the particles are shaped and/or have a size and/or are configured to facilitate fluid flow under compression within the housing.

4. An arrangement as claimed in claim 1 wherein the particles are all of similar size.

5. An arrangement as claimed in claim 1 wherein the particles have a smooth surface.

6. An arrangement as claimed in claim 1 wherein the engagement elements comprise fingers or pins projecting from the housing.

7. An arrangement as claimed in claim 1 wherein the engagement elements have a round or square cross section.

8. An arrangement as claimed in claim 1 wherein the engagement elements include a waisted rebate or slot for engagement by the means to retain the engagement members in the housing.

9. An arrangement as claimed in claim 8 wherein the rebates or slots in adjacent engagement elements overlap.

10. An arrangement as claimed in claim 8 wherein retainer members engage the waisted rebates or slots to retain engagement element position in the housing.

11. An arrangement as claimed in claim 8 wherein the retainer members comprises a pin or bolt drivable inwards within the waisted rebate.

12. An arrangement as claimed in claim 1 wherein the retainer members include wires to retain the elements.

13. An arrangement as claimed in claim 1 wherein more than one engagement element may be secured together for collective displacement.

14. An arrangement as claimed in claim 1 wherein the volume of particles can be locked by mechanical force or an adhesive or variable rheology fluid within which the volume of particles is suspended.

15. An arrangement as claimed in claim 1 wherein the engagement members have rounded ends.

16. An arrangement as claimed in claim 1 wherein the volume of particles is displaced by a plate and axial actuator.

17. An arrangement as claimed in claim 16 wherein the axial actuator is a rod or a piston.

18. An arrangement as claimed in claim 17 wherein the rod or piston is associated with the plate on one side of the volume of particles and the engagement members are on the other side of the volume of particles.

19. An arrangement as claimed in claim 16 and any claim dependent thereon wherein the axial actuator operates through a screw bolt or mechanical or electrical displacement mechanism.

20. An arrangement as claimed in claim 1 wherein the volume of particles incorporates a lubricant or gel or gas to facilitate fluid movement of otherwise solid particles.

21. An arrangement as claimed in claim 1 wherein the aperture in the housing is straight or circular or arcuate.

22. An arrangement as claimed in claim 1 wherein engagement elements are relatively upstanding in order to support a component by relative displacement of the engagement elements.

23. An arrangement as claimed in claim 22 wherein respective sets of engagement elements have an associated volume of particles.

24. An arrangement as claimed in claim 22 wherein all engagement elements are presented upon a common volume of particles through respective portions of the cavity containing the volume of particles.

25. An arrangement as claimed in claim 1 wherein the engagement elements engage jaw elements having a sympathetic or reciprocal shaping to a component to be supported.

26. (canceled)

27. An apparatus comprising two arrangements as claimed in claim 1 in opposition to each other with the respective engagement elements facing each other to define a vice or holding assembly.

28. An apparatus as claimed in claim 18 wherein each of the arrangements is presented upon a base and the base is relatively displaceable in order to further facilitate presentation between the engagement members.

29. (canceled)
